(19) United States
(12) Patent Application Publication
(10) Pub. No.: US 2024/0325118 A1
(43) Pub. Date: Oct. 3, 2024

(54) ORTHODONTIC DEVICE, PACKAGE, PROCESS OF MANUFACTURING ORTHODONTIC DEVICE, AND PROCESS OF USING ORTHODONTIC DEVICE

(71) Applicant: Ornge Orthodontics Inc., Hicksville, NY (US)

(72) Inventors: Ammar SYED, Unionville (CA); Colin J. COREY, Carlsbad, CA (US); Edward L. MASSARO, Bryn Mawr, PA (US)

(73) Assignee: Ornge Orthodontics Inc., Hicksville, NY (US)

(21) Appl. No.: 18/623,608

(22) Filed: Apr. 1, 2024

Related U.S. Application Data
(60) Provisional application No. 63/594,378, filed on Oct. 30, 2023.
(60) Provisional application No. 63/493,930, filed on Apr. 3, 2023.
(60) Provisional application No. 63/493,929, filed on Apr. 3, 2023.

(51) Int. Cl. A61C 7/14

(52) U.S. Cl. CPC A61C 7/146; A61C 2202/00

(57) ABSTRACT

An orthodontic device includes a positioning member integrally formed with a support member. A positioning member includes at least one recess structured to receive a portion of a tooth. A support member includes at least one cavity structured to detachably retain an orthodontic bracket. An orthodontic device optionally includes one or more orthodontic brackets detachably retained by one or more cavities. A package includes sealed packaging containing an orthodontic device. A process of manufacturing an orthodontic device includes using an additive manufacturing to produce the orthodontic device in one piece. A process of using an orthodontic device includes providing an orthodontic device including one or more orthodontic brackets and bonding the one or more brackets to teeth.

### CROSS-REFERENCE TO RELATED APPLICATIONS

This application claims priority of U.S. Provisional Patent Application No. 63/594,378, filed Oct. 30, 2023, U.S. Provisional Patent Application No. 63/493,930, filed Apr. 3, 2023, and U.S. Provisional Patent Application No. 63/493,929, filed Apr. 3, 2023, the entire content of each which is incorporated herein by reference.

### FIELD

The present application relates generally to orthodontics, and more specifically relates to devices and methods associated with orthodontics.

### BACKGROUND

Orthodontic bracket placement is generally based on a patent's dentition and an orthodontic prescription for the dentition. A user can directly place orthodontic brackets on a patient's teeth by hand. Direct bracket placement relies on the user's knowledge and skill for accurate placement. Alternatively, a user can apply brackets to teeth by using an indirect bonding apparatus that holds and positions brackets for bonding to the teeth. The apparatus can decrease the time required for a user to place brackets on teeth relative to a direct bracket placement method. An indirect bonding apparatus can also decrease human error in bracket placement relative to direct bracket placement.

The orthodontic industry has utilized additive manufacturing to produce indirect bonding apparatuses having a variety of structures. In some instances, an additive manufacturing process integrally forms orthodontic brackets with an indirect bonding apparatus. Alternatively, an additive manufacturing process can produce an indirect bonding apparatus and a user can later install brackets in the apparatus. In either configuration, users may find existing structures of indirect bonding apparatuses to be cumbersome for applying brackets to a patient's dentition.

### BRIEF DESCRIPTION OF THE DRAWINGS

FIG. 1 illustrates a front perspective view of an embodiment of an orthodontic device;

FIG. 2 illustrates a left-side elevational view of the device shown in FIG. 1;

FIG. 3 illustrates a rear elevational view of the device shown in FIG. 1;

FIG. 4 illustrates a front elevational view of a portion of a support arm of the device shown in FIG. 1;

FIG. 5 illustrates a front perspective view of the portion of the support arm shown in FIG. 4;

FIG. 6 illustrates a front elevational view of an embodiment of an orthodontic bracket;

FIG. 7 illustrates a front perspective view of the bracket shown in FIG. 6;

FIG. 8 illustrates a front perspective view of the orthodontic device shown in FIG. 1 including a plurality of orthodontic brackets retained in cavities of the device;

FIG. 9 illustrates a right-side perspective view of a portion of a positioning arm and a support arm of the device shown in FIG. 8;

FIG. 10 illustrates a front elevational view of the portion of the support arm shown in FIG. 9;

FIG. 11 illustrates a right-side cross-section of the portion of the support arm shown in FIG. 10 taken along line 11-11;

FIG. 12 illustrates a perspective view of the cross-section shown in FIG. 11;

FIG. 13 illustrates a right-side cross-section of the portion of the support arm shown in FIG. 10 taken along line 13-13;

FIG. 14 illustrates the device of FIG. 8 positioned over a dentition;

FIG. 15 illustrates a top view of the device positioned over the dentition in FIG. 14;

FIG. 16 illustrates a top perspective view of a package containing the orthodontic device shown in FIG. 8;

FIG. 17 illustrates a front perspective view of another embodiment of an orthodontic device;

FIG. 18 illustrates a right-side elevational view of yet another embodiment of an orthodontic device including an embodiment of an actuation means;

FIG. 19 illustrates a rear elevational view of the device shown in FIG. 18;

FIG. 20 illustrates a side perspective view of the device in FIGS. 18 and 19 with the actuation means in a relaxed state;

FIG. 21 illustrates perspective view of the device shown in FIG. 18 in an actuated state;

FIG. 22 illustrates an embodiment of a process of manufacturing an orthodontic device; and

FIG. 23 illustrates an embodiment of a process of using an orthodontic device.

### DETAILED DESCRIPTION

An orthodontic device can generally comprise a positioning member and support member. In some forms, a positioning member can comprise a positioning arm and a support member can comprise a support arm. A positioning member can include one or more tooth receiving structures respectively defining one or more recesses in the positioning member. A tooth receiving structure can generally comprise part of a positioning member that forms boundaries of a recess and imparts structure to the recess. In some aspects, a plurality of recesses can be formed in one or more discrete locations that are spaced apart along a positioning member. In other aspects, a plurality of recesses can form a continuous trough along a positioning member.

A recess can be structured to receive a portion of one or more teeth in a patient's dentition. In some forms, a recess can receive at least an occlusal surface of a tooth of a patient's dentition and optionally at least one of at least part of a lingual surface or at least part of a facial surface of the tooth. A recess can comprise a receiving contour structured to receive a portion of a tooth depicted in a three-dimensional model of a patient's dentition. A receiving contour can be calculated from a surface contour of a tooth depicted in a three-dimensional model of a patient's dentition. In some forms, a structure of a receiving contour can be calculated as any of a negative impression, a Boolean subtract, or a mathematical best fit approximation of a surface contour of a patient's tooth depicted in a three-dimensional model.

A three-dimensional model of a patient's dentition can include surface topography information or surface contours of one or more of a patient's teeth or a patient's complete set of teeth. An electronic file can comprise a three-dimensional model of a patient's dentition that has been captured either directly from a patient's dentition or indirectly from an impression model of a patient's dentition. Examples of useful devices for measuring topography information from a patient's dentition include intraoral scan, cone beam computed tomography taken directly from a patient's dentition or indirectly from an impression model, and a laser scan of an impression model. The measured topography information can be processed by a computing device. The topography information can be generally saved in any useful format such as point cloud data, or any useful file utilized in computer-aided drafting (CAD). The information can be saved using any useful type of memory such as RAM, a solid-state drive, a hard disk, a network drive, or a cloud-based server. A computing device can be programmed to generate a three-dimensional model of a patient's dentition based on the topography information. Examples of a computing device useful in processes and methods provided herein include one or more of a personal computer, a network of computers such as computers connected to one or more of a local area network, a wireless network, a cellular network, and a cloud network.

A support member of an orthodontic device can include one or more bracket receiving structures respectively defining one or more cavities in the support member. A bracket receiving structure can generally comprise a part of a support member that forms boundaries of a cavity and imparts structure to the cavity. A cavity can comprise structure that detachably retains an orthodontic bracket including a bonding surface such that the bonding surface faces away from the cavity.

A positioning member and a support member can comprise a structure that aligns a bonding surface of one or more orthodontic brackets with a second portion of one more of the patient's teeth upon a first portion of the one or more teeth being received by one or more recesses formed in a positioning member and one or more orthodontic brackets being retained by one or more cavities formed in a support member. In some aspects, a positioning arm and a support arm can comprise structure that aligns bonding surfaces of one or more orthodontic brackets for contact and bonding with facial or lingual surfaces of one or more teeth in a patient's dentition upon at least occlusal surfaces of the one or more teeth being received in one or more recesses formed in a positioning member and the one or brackets being retained in one or more cavities formed in a support member.

An orthodontic device can generally be constructed in one piece from material such that the positioning member is integrally and continuously formed with the support member. In various forms, an orthodontic device can be made by an additive manufacturing process, a computer numerical control (CNC) process, a molding process, or any other process of capable of forming a positioning member and a support member as a singular unitary piece. In some forms, an additive manufacturing process can be used to construct an orthodontic device in one piece such that an end of a positioning member is integrally and continuously formed to an end of a support arm. In some forms, this connection between the positioning member and the support member can be the sole connection between the positioning member and the support member.

Examples of useful additive manufacturing processes include binder jetting, directed energy deposition, direct metal laser sintering, material extrusion, material jetting, powder bed fusion, sheet lamination, and vat polymerization. Examples of materials that can be used to construct an object such as an orthodontic device or an orthodontic bracket using additive manufacturing include polymers, metals, ceramics, and composites.

In some forms, one or more colorants, such as red, yellow, blue, or orange pigment or dye, can be incorporated into one or more materials used for additively manufacturing one or more of an orthodontic device and an orthodontic bracket.

An orthodontic device can further comprise a base connected to body including a positioning member and support member. An additive manufacturing process can connect a body to a base, and the connection between the base and the body can include at least one tapered portion that permits separation of the base from the body. A tapered portion can be frangible and severed by application of a separating force between the base and the body. A tapered portion can also be severed by cutting with a blade or a grinder.

In some forms, an additive manufacturing process can introduce one or more reinforcing members between a base and one or more of a positioning member and a support member. The reinforcing members can include tapered portions between one or more of a base and a reinforcing member, a support member and a reinforcing member, and positioning member and a reinforcing member. Any reinforcing members can be optionally removed before use of an orthodontic device by severing tapered portions between any reinforcing members and a base, a positioning member, and a support member.

An orthodontic device can generally be made in one piece by an additive manufacturing process such that a support member includes one or more cavities not including orthodontic brackets retained therein. One or more orthodontic brackets can be made separately from an orthodontic device by any one or more useful processes such as injecting molding and additive manufacturing. Examples of injecting molding processes include metal injection molding and plastic or resin injecting molding. An orthodontic bracket can generally comprise a bracket portion and a base portion. An orthodontic bracket can comprise a bracket portion and a base portion formed together as one piece by any process such as additive manufacturing or injection molding. In some forms, an orthodontic bracket can comprise an orthodontic bracket assembly including a bracket portion and a base portion that are formed separately and then attached together. The entire contents of U.S. Provisional Application No. 63/493,929 titled “Orthodontic Bracket Assembly, Process of Manufacturing Orthodontic Bracket Assembly, and Process of Manufacturing Orthodontic Appliance,” and U.S. Provisional Application No. 63/493,930 titled “Orthodontic Bracket Assembly and Process of Manufacturing Orthodontic Bracket Assembly” are incorporated herein by reference for all purposes.

An orthodontic bracket formed in one piece or as an orthodontic bracket assembly, in either case, can include a first surface structured to face away from a surface of any tooth to which the orthodontic bracket can be attached, and a bonding surface formed on a base of the bracket. A bonding surface can be structured to contact a tooth. An archwire slot can be formed in and accessible on a first surface of a bracket. An archwire slot can have an axis configured to lie generally along a mesial-distal direction of a tooth to which a bracket assembly is configured to be attached. In some forms, an archwire slot can be open across a first side of a body of a bracket portion. In other some forms, an archwire slot can comprise a molar tube fixed to or otherwise formed on the first side of the body.

An orthodontic bracket can comprise one or more structures for retaining an archwire in an archwire slot. An orthodontic bracket can optionally comprise one or more ligature-retaining structures configured to receive one or more ligatures and retain an archwire. A ligature can generally be attached to one or more ligature-retaining structures to hold an archwire in an archwire slot. In various forms, a ligature can comprise a metal wire, a plastic member, or an elastomeric band that can be attached to a ligature-retaining structure. In some forms, a first surface of an orthodontic bracket can comprise at least two ligature-retaining structures, such as tie wings, where a first of the ligature-retaining structures extends in a first direction lateral to an archwire slot and a second of the ligature-retaining structures extends in a second direction lateral to the archwire slot. In some forms, the first and second directions can be, respectfully, in a generally gingival direction toward a gum line of a tooth to which an orthodontic bracket is configured to be attached, and in an occlusal direction generally toward an occlusal plane corresponding to the same tooth. In some forms, a first surface of an orthodontic bracket can include a pair of spaced apart occlusal tiewings extending transversely in generally occlusal directions from an archwire slot and a pair of spaced apart gingival tiewings extending transversely in generally gingival directions from the archwire slot.

In other forms, an orthodontic bracket can include a self-ligating mechanism configured to close over and retain an archwire in an archwire slot. In some forms, a first surface of a bracket comprises a self-ligating mechanism such as a hinged door, a sliding door, or clasp. A hinged or sliding door or a clasp can be opened to permit insertion of an archwire in an archwire slot and then closed to retain the archwire in the slot. Similarly, a hinged or sliding door or a clasp of a self-ligating mechanism can be opened to permit removal of an archwire from the slot. An orthodontic bracket can include a hook configured to retain part of an elastic tie configured to span maxillary and mandibular components of an orthodontic appliance such as braces. In some forms, a hook can be added to a bracket after fixing the bracket to a patient's tooth.

In some aspects, an orthodontic bracket can be formed such that the bonding surface includes one or more of a base contour, undercut structures, cavities, and a porous structure. A bonding material or adhesive can be applied to a bonding surface. Transbond™ XT marketed by 3M™ is example of a bonding material or adhesive. Undercut structures, cavities or porous structures can be configured to receive and retain a desired amount of bonding material or adhesive to be interposed between a surface of a tooth and the bonding surface of the bracket so as to provide strong adhesion of a base portion to a tooth surface. In some forms, an orthodontic bracket can be formed at least in part by an additive manufacturing process such that the bonding surface includes one or more of a base contour, undercut structures, cavities, and a porous structure.

A base contour of an orthodontic bracket can be structured to receive a surface contour of a patient's tooth to which base of the bracket is configured to be attached. A base contour can be calculated from a surface contour of a tooth depicted in a three-dimensional model of a patient's dentition. In some forms, a structure of a base contour can be calculated as any of a negative impression, a Boolean subtract, or a mathematical best fit approximation of a surface contour of a patient's tooth depicted in a three-dimensional model.

When an orthodontic device includes at least one bracket retained in a cavity of a support member, and a bonding surface of a retained bracket includes a base contour structured to interface with an intended bonding location of a tooth, the base contour can aid in positioning of the orthodontic device and bracket at the intended bonding location. The base contour can noticeably engage the bonding location when the orthodontic device correctly positioned.

An orthodontic device can include one or more orthodontic brackets by inserting a bracket into a cavity of a support member such that a bonding surface of the bracket is disposed away from the cavity in an orientation suitable for bonding to a tooth surface. A cavity of a support member can be structured to receive any one more of a ligature retaining structure, an archwire slot, a self-ligating mechanism, a ligature, and an archwire.

A cavity of a support member can include one or more retention structures that can retain a bracket in the cavity. A retention structure can generally include any structure formed to engage and retain any portion of a bracket. In some forms, one or more retention structures engage an underside edge of one or more tie wings of a bracket. A first surface of bracket can be pressed into a cavity such that one or more tie wings are advanced past respective retention structures formed in the cavity and the retention structures engage underside edges the tie wings with the retention structures at least partially disposed in a gap between the tic wings and a base of a bracket. The bracket can be removed by pulling the bracket from the cavity and drawing the one or more tie wings past retention structures until the bracket is removed from the cavity. In another form, an orthodontic bracket can include one or more retention structures to engage with one or more corners or sides of a bracket.

In other forms, a retention structure can include a friction fit between a structure inside the cavity and a corresponding structure of the bracket. For example, a friction fit can be established between a peripheral edge of one or more tie wings of a bracket and an interior structure of cavity such that the cavity tightly engages the peripheral edge. In another form, a retention structure can include a ridge within the cavity that is structured to tightly fit within an archwire slot of a bracket and detachably retain the bracket in the cavity through friction between the ridge and the archwire slot.

One or both of a bracket and an orthodontic device can be constructed of material that permits elastic structural deformation permitting snapping engagement of one or more retention structures of a cavity with one or more structures of a bracket or a friction fit between a cavity and a bracket.

In other forms, a cavity can detachably retain a bracket by providing an adhesive material between an interior of the cavity and a surface of the bracket such that the adhesive material temporarily retains the bracket in the cavity until the bonding surface of the bracket is attached to a tooth and the bracket can be removed from the cavity.

A package can include sealed packaging and an orthodontic device contained within the sealed packaging. In some forms, an orthodontic device contained in sealed packaging does not include one or more orthodontic brackets retained in one or cavities of a support arm. In other forms, an orthodontic device contained in sealed packaging can include one or more orthodontic brackets retained in one or cavities of a support arm. In some aspects, an orthodontic device contained in sealed packaging includes one or more orthodontic brackets retained in one or cavities of a support arm and adhesive pasted to bonding surfaces of the one or more brackets. Sealed packaging can include any suitable material such as any one or more of polymers and metal. In some forms, sealed packaging includes one or more of polymeric film, metalized polymeric film, and metal foil. In some forms, sealed packaging can be formed from single layer or multilayered film disposed around an orthodontic device and heat sealed to contain the device. In other forms, sealed packaging can include film sealed with adhesive to contain an orthodontic device. In yet other forms, sealed packaging can comprise a blister pack enclosing an orthodontic device. Sealed packaging can have one or more properties. In some forms, sealed packaging can be one or more of light shielding and resistant to gas permeation. It is generally thought that packing including one or more materials that are one or both of light shielding and resistant to gas permeation can preserve adhesive attached to bonding surfaces of brackets. In some forms, sealed packaging can be filled with an inert gas such as nitrogen, while substantially or fully omitting oxygen. In some aspects, the interior of sealed packaging and an contained orthodontic device contained in the packaging can be sterile.

Some indirect bonding (IDB) devices can be constructed from one or more resins that impart the IDB devices with a relatively low elasticity. These IDB devices can have highly flexible and soft characteristics. Such IDB devices can deform relatively easily when a user applies pressure to a point on the device. Due to the soft nature, when a user places such an IDB device holding brackets on a patient's dentition and then applies sufficient pressure to a part of the device to cause deformation of the device, the deformation of one part of the device can propagate through the device and move brackets out of desired position. For example, sufficient pressure applied to an IDB tray formed of soft material can deform the tray and affect positioning of brackets on teeth.

In some aspects, an orthodontic device can be construed by an additive manufacturing process using one or more elastic material materials, such as one or more polymeric substances that, when cured, impart the orthodontic device with relatively higher elasticity than would be exhibited by an IDB device exhibiting more flexible and soft properties. BioMed Clear and Dental LT Clear marketed by Formlabs, Inc. and NightGuard Flex marketed by SprintRay, Inc. are examples of polymeric resins that are thought to impart desired elasticity to orthodontic devices when cured. Without intending to be constrained by any theory, it is thought materials imparting higher elasticity to an orthodontic device can limit undesired deformation of the device and positional deflection of orthodontic brackets retained by the device when a user applies pressure to one or more parts of the device.

In some forms, an orthodontic device can comprise a positioning member and support member, the positioning member and the support member can include an elastic material, and the orthodontic device can include an actuation means structured to move the support member away from a root axis of a recess of the positioning member upon engagement of the actuation means. A root axis of a recess can align or otherwise coincide with a root axis of a tooth for which the recess is structured to receive, upon the recess receiving the tooth. In some aspects when a user seeks to position an orthodontic device on a patient's dentition with a support member of the device detachably retaining an orthodontic bracket, the user may desire insert a tooth into a recess of a positioning member without any adhesive or bonding material on a bonding surface of the bracket contacting or scraping against a lingual or facial surface of the tooth. Engagement of an actuation means can pull a support member and a bonding surface of a bracket retained by the support member into a position where any adhesive or bonding material on the bonding surface is pulled away from the tooth and undisturbed when inserting the tooth into the recess.

An actuation means can include any useful structure. In some forms, an actuation means can include one or more tabs fixed to a support member. A user can pull or press a tab to move the support member away from a root axis of a recess of a positioning member. In other aspects, an actuation means can include a member, such as a wedge, attached to the orthodontic device. A user can press the member into a position between a positioning member and a support member to move the support member away from a root axis of a recess of a positioning member.

In yet other forms, an actuation means can include a first rocker member fixed to a positioning member and a second rocker member fixed to a support member. The first rocker member can include a fulcrum surface, the second rocker member can include a fulcrum surface, and the two fulcrum surfaces can face each other. The first rocker member and the second rocker member can be structured to move a support member away from a root axis of a recess of a positioning member upon compressing together the first rocker member and the second rocker member such that a distance between a tip of the first rocker member and a tip of the second rocker member decreases and the fulcrum surface of the first rocker member actuates against the fulcrum surface of the second rocker member.

In some forms, fulcrum surfaces of first and second rocker members can comprise convex surfaces that face each other. The first rocker member and the second rocker member can be structured to move a support member away from a root axis of a recess of a positioning member upon compressing together the first rocker member and the second rocker member such that a distance between a tip of the first rocker member and a tip of the second rocker member decreases and the convex surface of the first rocker member rocks against the convex surface of the second rocker member.

In other forms, an actuation means can include a first actuation member including a ball and a second actuation member including a socket. The first actuation member can be fixed to one of a positioning member and a support member, and the second actuation member can be fixed to the other of the positioning member and the support member. The first actuation member and the second actuation member can be structured to move a support member away from a root axis of a recess of a positioning member upon compressing together the first actuation member and the second actuation member such that a distance between a tip of the first actuation member and a tip of the second actuation member decreases, and the ball comes together with and rotates within the socket.

In yet other forms, an actuation means can include a first actuation member including a pin and a second actuation member including a concave groove having a c-shaped cross-section structured to receive the pin laterally within the groove such that an axis of the pin aligns with an axis of the groove. The first actuation member can be fixed to one of a positioning member and a support member, and the second actuation member can be fixed to the other of the positioning member and the support member. The first actuation member and the second actuation member can be structured to move a support member away from a root axis of a recess of a positioning member upon compressing together the first actuation member and the second actuation member such that a distance between a tip of the first actuation member and a tip of the second actuation member decreases, the pin comes together with the groove, an axis of the pin aligns with an axis the groove, and the pin rotates within the groove.

It is also thought that an orthodontic device including a positioning member and a support member, and having a branched structure wherein a connection between one end of the positioning member and one end of the support member is the sole connection between positioning member and the support member, can provide structural independence between the positioning member contacting one or more teeth and the support member retaining one or more orthodontic brackets. This structural independence is thought to inhibit substantial deflection of positioning of an orthodontic bracket if a user applies pressure to one or more parts of the positioning member contacting a patient's dentition. It is also thought that branched structure of an orthodontic device provided herein can permit a user to view a patient's dentition when bonding orthodontic brackets using the device, when compared to prior IDB devices that may have large and obtrusive structures.

In some forms, a process of manufacturing an orthodontic device can comprise importing or saving to a computing device, in any order or simultaneously, one or more of a three-dimensional model obtained from a patient's dentition, an orthodontic prescription for the patient's dentition, and a structural model for one or more orthodontic brackets including bonding surfaces. From information imported or saved, the computing device can generate a data file including structure data for an orthodontic device. The data file can generally include any one or more structures of an orthodontic device provided herein or contemplated from the present disclosure. The data file can then be imported and saved to an additive manufacturing device. The additive manufacturing device can then produce an orthodontic device by an additive manufacturing process such that the orthodontic device is made in one piece. A process of manufacturing an orthodontic device can also include inserting one or more separately formed orthodontic brackets into respective cavities of the orthodontic device that has been produced by the additive manufacturing process. Together, the orthodontic device and the one or more orthodontic brackets can be used to place the one or more brackets in intended positions on a patient's dentition based on the three dimensional model, the orthodontic prescription and the structural model of the one or more brackets.

An additive manufacturing process can be controlled by a computing device programmed to control process parameters of an additive manufacturing apparatus to construct a three-dimensional object such as an orthodontic device.

In some forms, a process of using an orthodontic device can include providing an orthodontic device comprising one or more orthodontic brackets detachably retained by one or more respective cavities of the device, disposing at least an occlusal surface of one or more of a patient's teeth in one or more recesses formed in the orthodontic device such that a positioning arm and a support arm of the device align bonding surfaces of the one or more orthodontic brackets with facial or lingual surfaces of one or more teeth. A process can optionally comprise engaging an actuation means to pull a support member retaining one or brackets away from one or more root axes of one or more corresponding recesses of a positioning member before disposing an occlusal surface of one or more teeth into the one or more recesses. The process can further include bonding the bonding surfaces of the one or more orthodontic brackets to the facial or lingual surfaces of the teeth, and then removing the positioning arm and the support arm from the patient's teeth with the one or more orthodontic brackets remaining bonded to the teeth. In some aspects, the process can further comprise curing an adhesive contacting the bonding surfaces of the one or more brackets and the facial or lingual surfaces of the teeth.

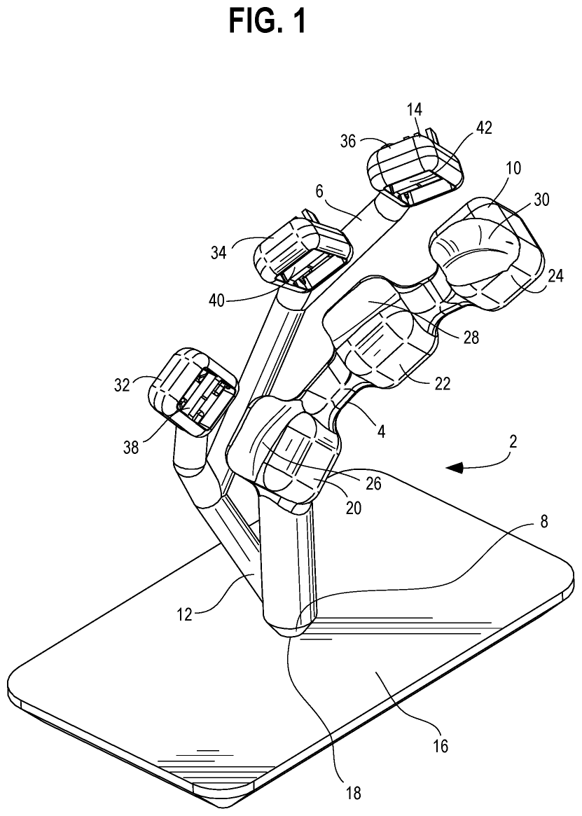

FIGS. 1-3 illustrate an embodiment of an orthodontic device 2 that was made using an additive manufacturing process. The device includes a positioning arm 4 and a support arm 6. The positioning arm 4 includes a first end 8 and a second end 10, and the support arm 6 includes a first end 12 a second end 14. The orthodontic device 2 has been made in one piece by the additive manufacturing process such that the first end 8 of the positioning arm 4 is integrally and continuously formed to the first end 12 of the support arm 6. The integral and continuous connection between the positioning arm 4 and support arm 6 is the sole connection between the positioning arm 4 and support arm 6. The body of the device including the positioning arm 4 and the support arm 6 is also fixed to a base 16 during the additive manufacturing process. The connection to the base includes a tapered portion 18 having a narrowed cross-section establishing a frangible connection that can be broken or otherwise severed to separate the base 16 from the body including the positioning arm 4 and support arm 6.

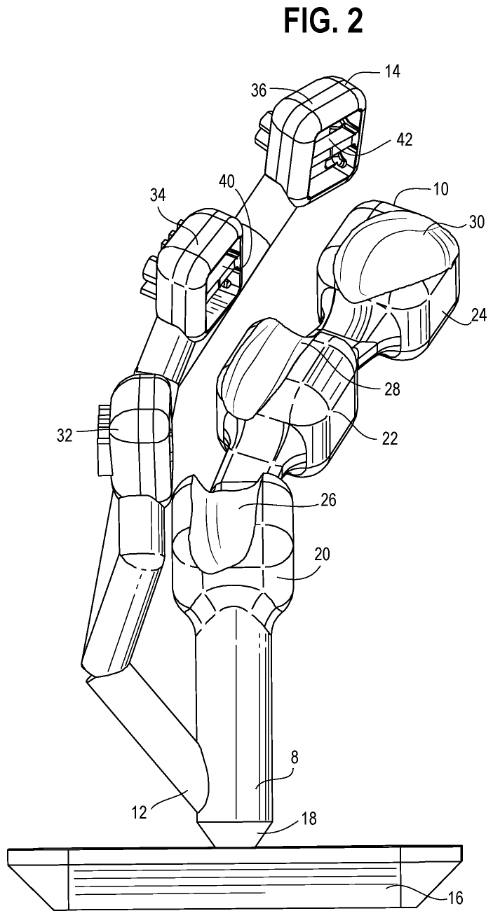

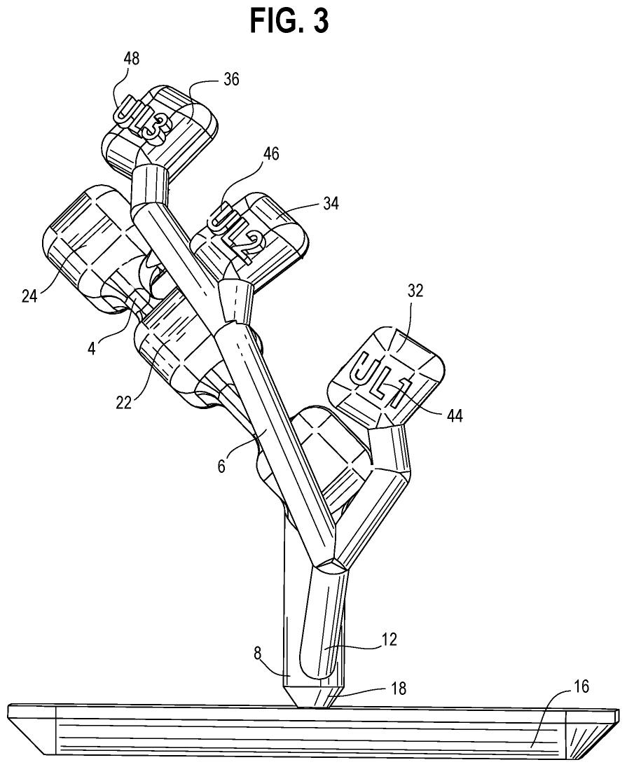

The positioning arm 4 includes a plurality of tooth receiving structures 20, 22, 24, defining recesses 26, 28, 30. One of the recesses 30 is formed proximal to the second end 10 of the positioning arm 4. The recesses 26, 28, 30 are structured to receive at least occlusal surfaces of a patient's teeth depicted in a three-dimensional model of the patient's dentition. The support arm 6 includes a plurality of bracket receiving structures 32, 34, 36 defining cavities 38, 40, 42. One of the cavities 42 is formed proximal the second end 14 of the support arm 6. The cavities 38, 40, 42 are each structured to receive and detachably retain an orthodontic bracket including a bonding surface. The positioning arm 4 and the support arm 6 are structured to align bonding surfaces of orthodontic brackets with facial or lingual surfaces of a patient's teeth upon at least occlusal surfaces of the teeth being received by the recesses 26, 28, 30 and orthodontic brackets being retained by the cavities 38, 40, 42. The cavities 38, 40, 42 shown in FIGS. 1 and 2 are not in a state of retaining orthodontic brackets. Orthodontic brackets are not integrally and continuously formed by additive manufacturing with the positioning member and the support member. FIG. 3 further shows that the backsides of bracket receiving structures 32, 34, 36 include different indicia 44, 46, 48 designating a position in a patient's dentition over which the bracket receiving structures can be positioned.

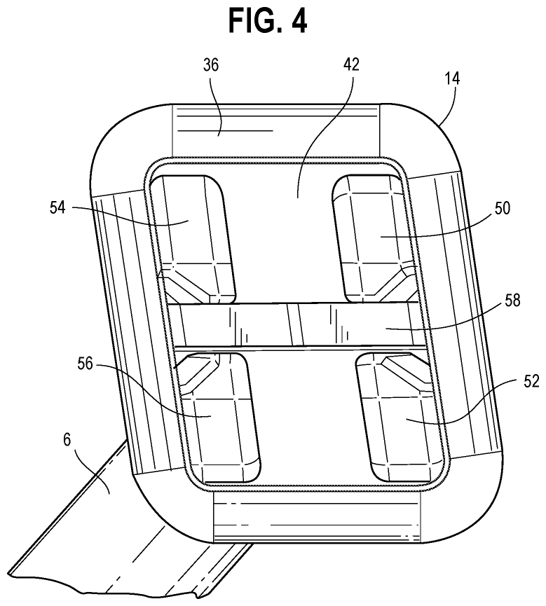

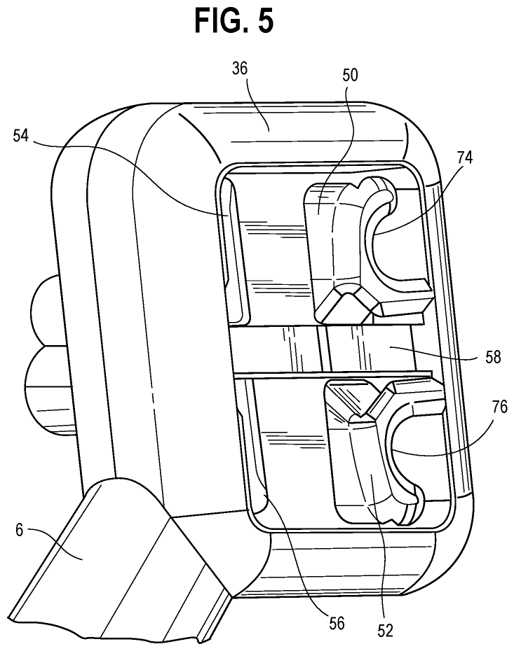

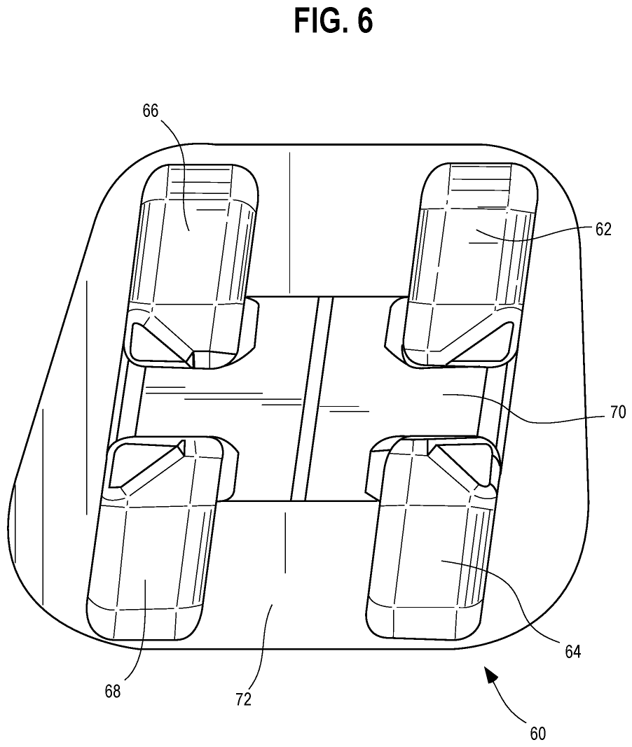

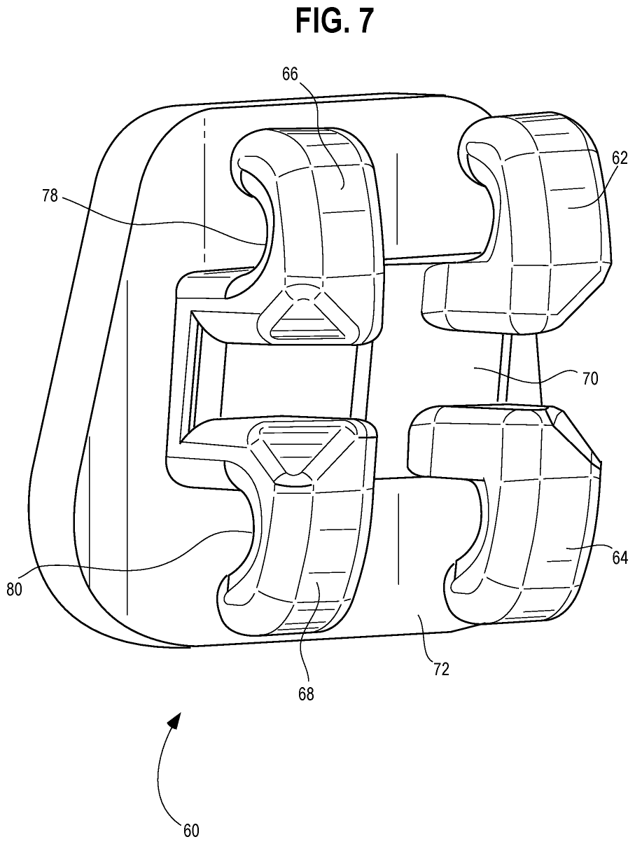

FIGS. 4 and 5 respectively show front elevational and perspective views of the bracket receiving structure 36 proximal the second end 14 of the support arm 6 shown in FIG. 1. The bracket receiving structure 36 defines cavity 42 including four depressions 50, 52, 54, 56 and ridge 58. FIGS. 6 and 7 respectively show a front elevational and perspective views of an embodiment of an orthodontic bracket 60 including tie wings 62, 64, 66, 68, an archwire slot 70, and a base 72. In FIGS. 4 and 5, depression 50 of the cavity 42 is structured to receive tie wing 66, depression 52 is structured to receive tie wing 68, depression 54 is structured to receive tie wing 62, and depression 56 is structured to receive tie wing 64.

FIG. 5 shows that the cavity 42 defined by the bracket receiving structure 36 includes retention structures 74, 76 that are respectively formed in depressions 50, 52. Retention structures are also formed in depressions 54, 56 but are not visible due to the perspective view of the bracket receiving structure shown in FIG. 5. Retention structure 74 is formed to retain the underside edge 78 of tie wing 66 of the bracket 60 shown in FIG. 7. Similarly, retention structure 76 is formed to retain the underside edge 80 of tie wing 68. The retention structures formed in depressions 54, 56 and not visible in FIG. 5 but are respectively formed to retain underside edges of tie wings 62, 64 of the bracket 60. The cavity 42 defined by the bracket receiving structure 36 further includes a ridge 58 structured to fit within the archwire slot 38 of the bracket 60. The bracket receiving structures 32, 34 shown in FIG. 1 also include cavities 38, 40 also including ridges, depressions, and retention structures like those of bracket receiving structure 36. However, in other embodiments, an orthodontic device can include a plurality of bracket receiving structures defining cavities including different structures for receiving and retaining brackets or other orthodontic appliances.

The tie wings 62, 64, 66, 66 of the bracket shown in FIGS. 6 and 7 can be pressed into the cavity 42 of the bracket receiving structure shown in FIGS. 4 and 5 such that the tie wings snap past the retention structures and fit within depressions 50, 52, 54, 56. After the bracket 60 is pressed into the cavity, the retention structures detachably retain the bracket in the cavity. The bracket 60 can be removed by pulling the bracket from the cavity such that the tie wings withdraw from the depressions and snap past the retention structures.

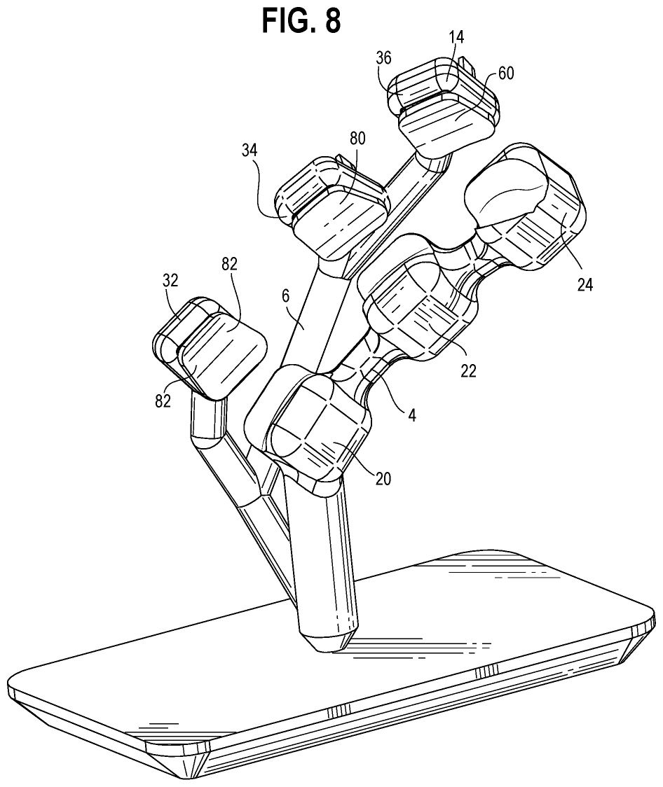

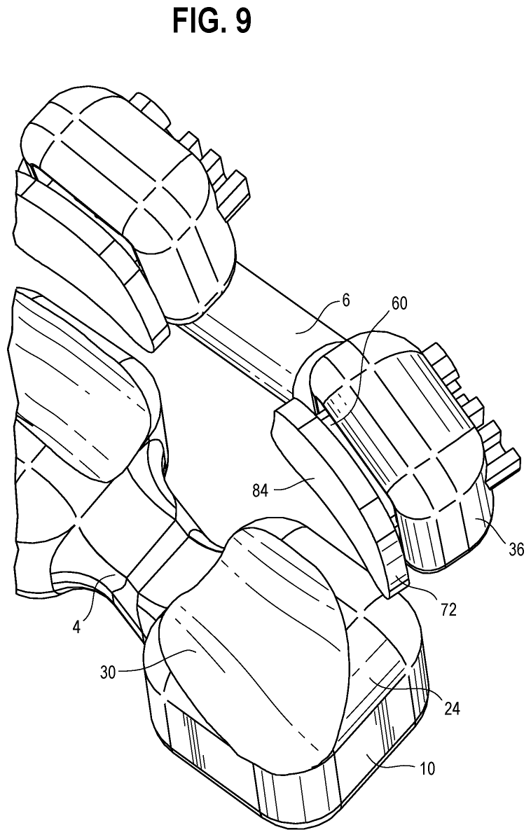

FIG. 8 illustrates the orthodontic device 2 shown in FIG. 1 further including orthodontic brackets 60, 80, 82 detachably retained in bracket receiving structures 36, 34, 32. FIG. 9 shows a perspective view of the bracket receiving structure 36 formed proximal to the second end 14 of the support arm 6 of the device 2 shown in FIG. 8. The bracket 60 is retained by the cavity of the bracket receiving structure 36. A bonding surface 84 of the base 72 of the bracket is positioned proximal the recess 30 defined by tooth receiving structure 24 so that when the recess receives a surface of a tooth, the bonding surface of the bracket can be positioned to contact another surface of the tooth.

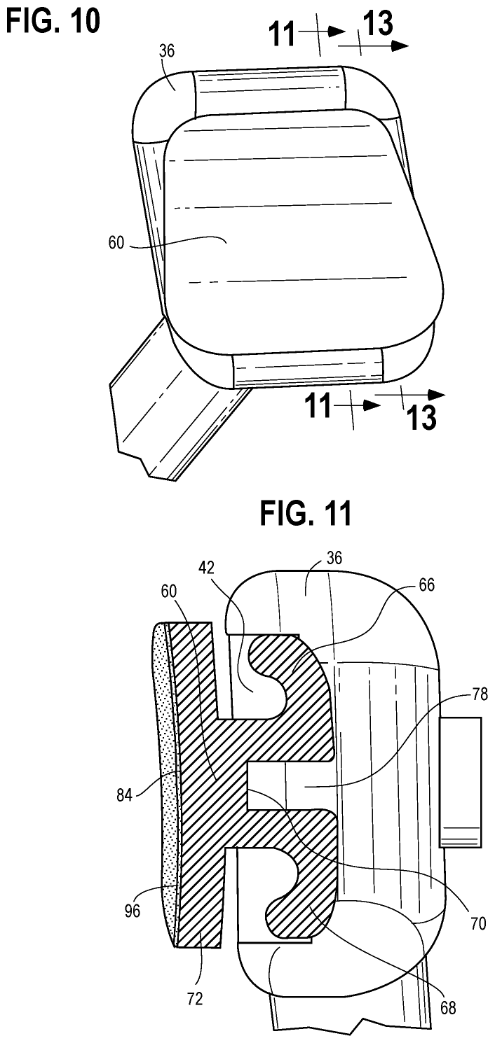

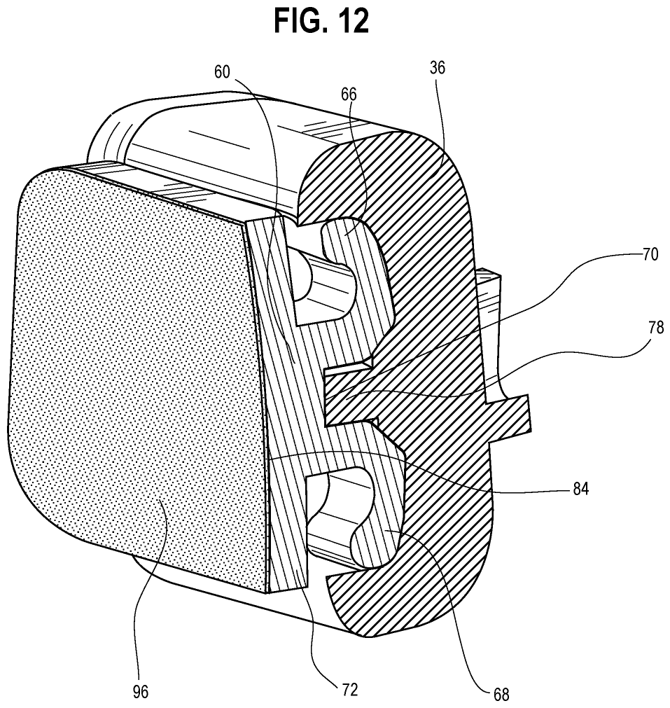

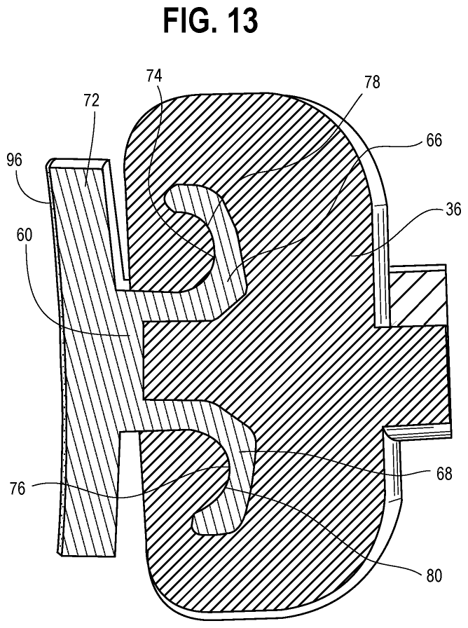

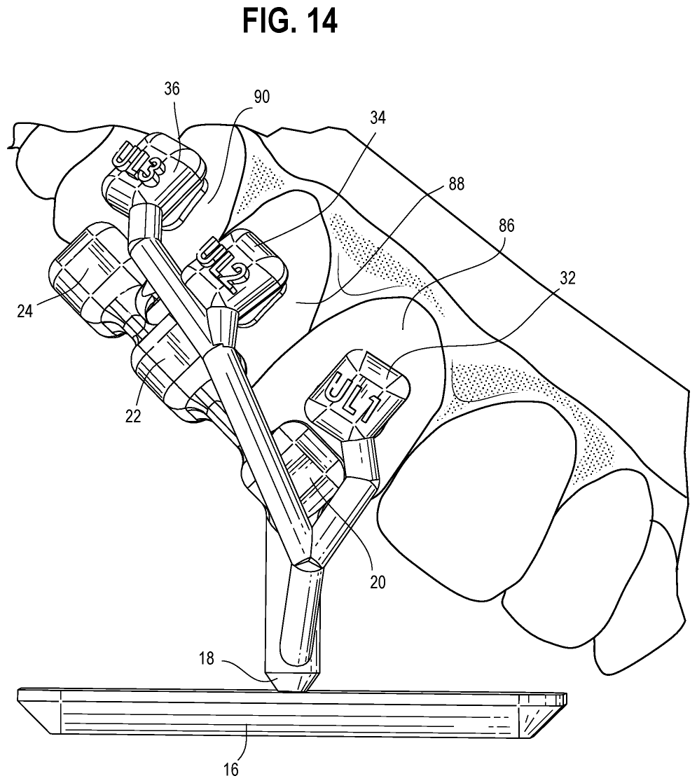

FIG. 10 shows a front elevational view of bracket receiving structure 36 retaining bracket 60. FIGS. 11 and 12 respectively show elevational and perspective views of a cross-section of the bracket receiving structure 36 taken along line 11-11 in FIG. 10. Cross-sections of tie wings 66, 68 are visible within cavity 42. The bonding surface 84 of the base 72 of the bracket 60 is exposed outward away from the bracket receiving structure 36 and is covered with adhesive 96. The ridge 78 is disposed within the archwire slot 70 of the bracket 60. FIG. 13 shows an elevational view of a cross-section of the bracket receiving structure 36 taken along line 13-13 in FIG. 10. FIG. 13 shows a cross-section at a point where retention structures 74, 76 respectively engage underside edges 78, 80 of tie wings 66, 68.

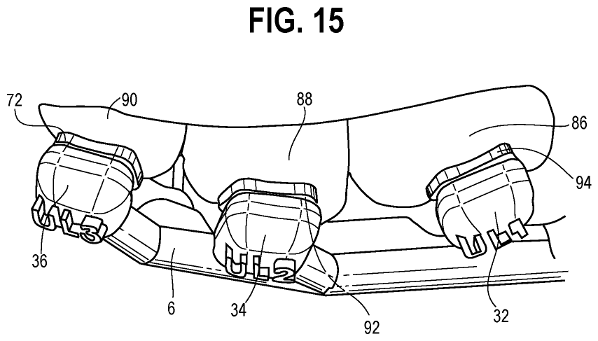

FIGS. 14 and 15 respectively show rear and top perspective views of the device 2 shown in FIG. 8 positioned over a portion of a patient's dentition. The recesses of tooth receiving structures 20, 22, 24 respectively receive occlusal surfaces of teeth 86, 88, 90 such that the bracket receiving structures 32, 34, 36 are respectively positioned over portions of teeth 86, 88, 90. The bonding surfaces of bases 72, 92, 94 respectively cover portions of facial surfaces of teeth 86, 88, 90. While FIG. 14 shows the base 16 connected to the positioning arm 4 and support arm 6, the base can be optionally removed prior to positioning the device over a patient's dentition by separating the base 16 at the tapered portion 18.

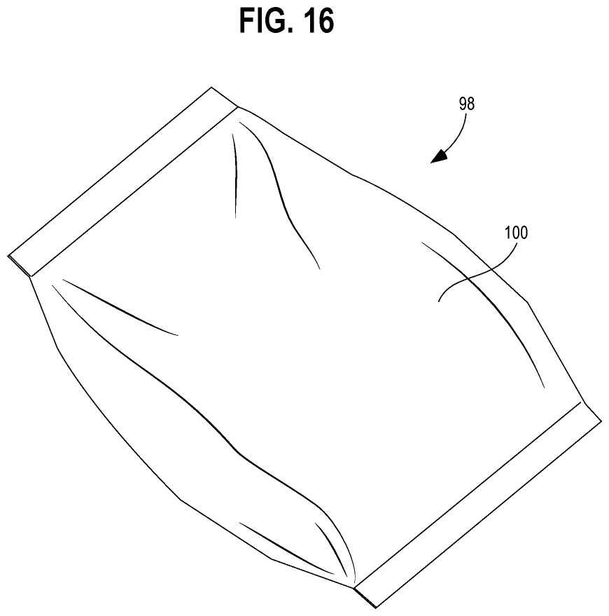

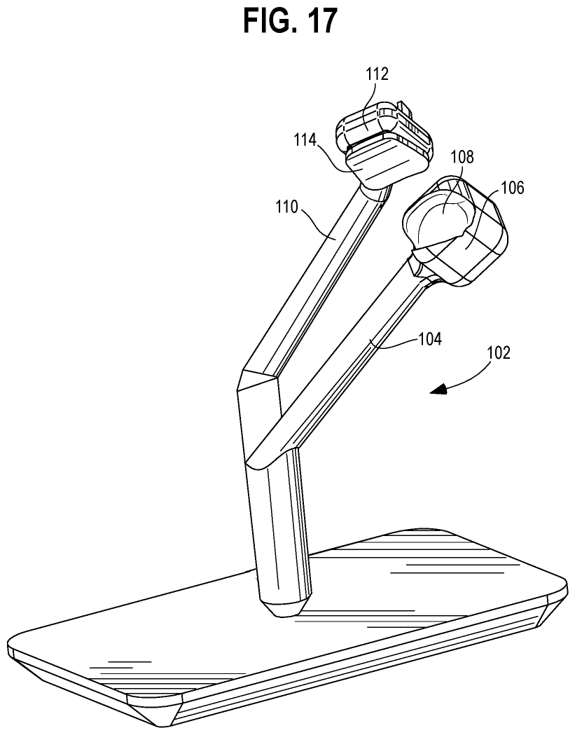

FIG. 16 shows an embodiment of a package 98 including sealed packaging 100. Enclosed within the sealed packaging is the orthodontic device shown in FIG. 8 including adhesive applied to bonding surfaces of the orthodontic brackets.

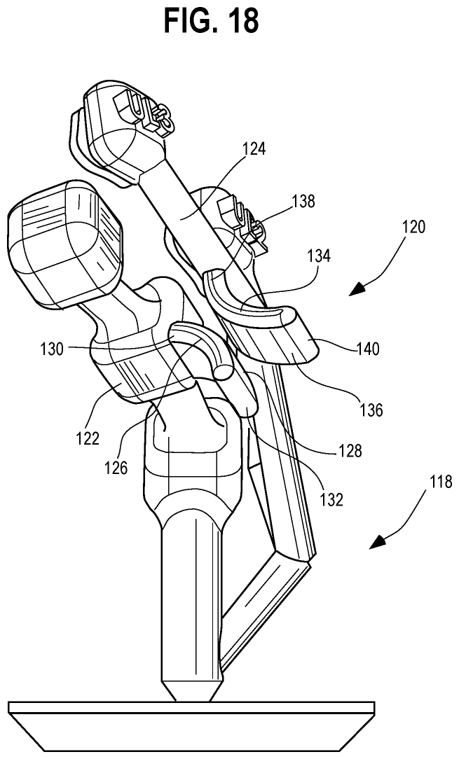

FIG. 17 illustrates another embodiment of an orthodontic device 102 including a positioning arm 104 including a tooth receiving structure 106 defining a recess 108 structured to receive a portion of a tooth. The device 102 further includes a support arm 110 including a bracket receiving structure 112 including a cavity detachably retaining a bracket 114. The orthodontic device has been formed in one piece by an additive manufacturing process such that an end of the support arm 110 is integrally can continuously to an end of the positioning arm 104.

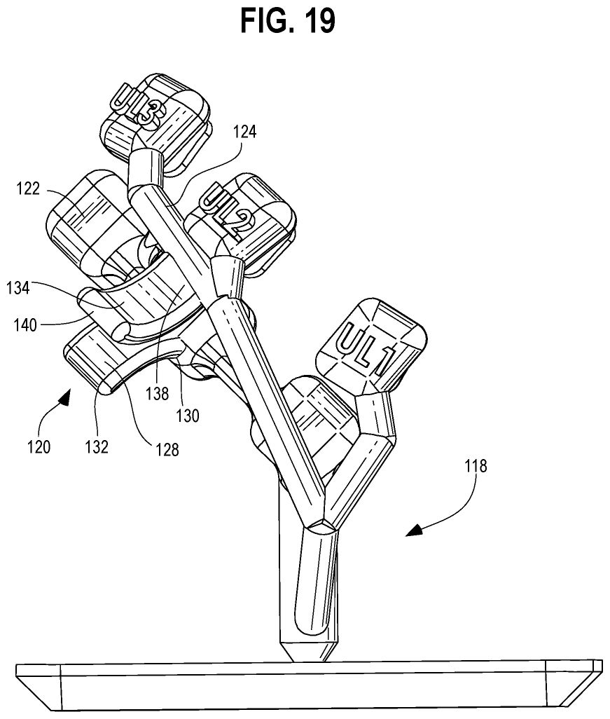

FIGS. 18 and 19 show an embodiment of an orthodontic device 118 including an actuation means 120. The orthodontic device has been constructed in one piece by an additive manufacturing process such that a positioning arm 122 and a support arm 124 include an elastic material. The actuation means includes a first rocker member 126 and a second rocker member 134. The first rocker member includes a convex surface 128, a base 130 fixed to the positioning arm 122, and a tip 132 extending radially from the positioning arm. The second rocker member 134 includes a convex surface 136, a base 138 fixed to the support arm 124, and a tip 140 extending radially from the support arm and proximal the tip 132 of the first rocker member 126.

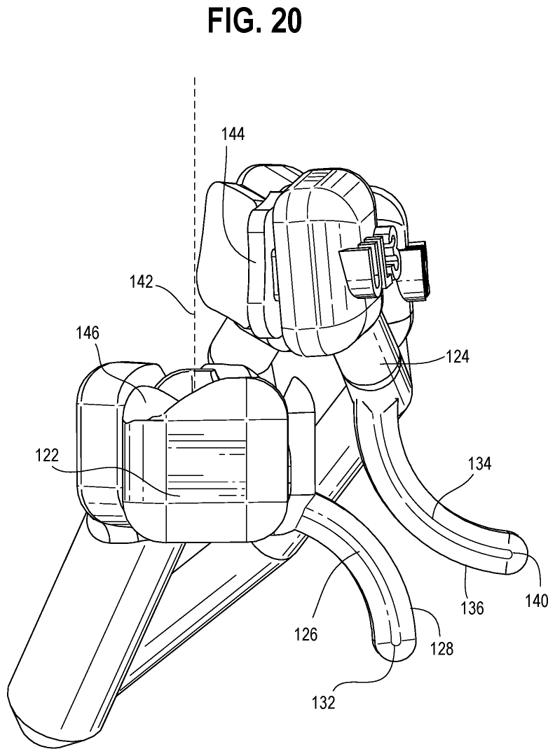

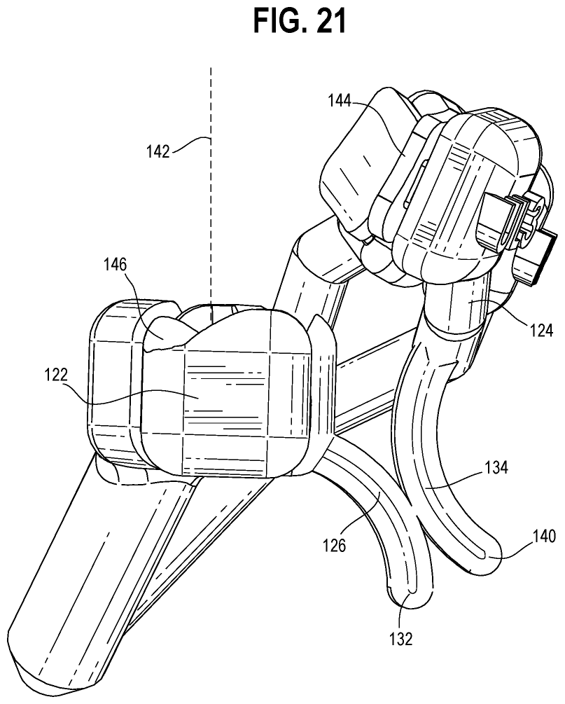

FIG. 20 shows the device in FIGS. 18 and 19 with the actuation means in a relaxed state. A base of the device has been removed. The first rocker member 126 and the second rocker member 134 are structured to move the support arm 124 away from a root axis 142 of a recess 146 of the positioning arm 122 upon compressing together the first rocker member 126 and the second rocker member 134 such that the distance between the tip 132 of the first rocker member and the tip 140 of the second rocker member decreases and the convex surface 128 of the first rocker member rocks against the convex surface 136 of the second rocker member. FIG. 21 shows the device in FIG. 20 with the actuation means in an actuated state. A user can at least partially compress together the tips 132, 140 of the rocker members 126, 134 to draw a bonding surface 144 of an orthodontic bracket away from the root axis 142 of the recess. After a tooth is positioned in the recess, the user can release the tips 132, 140 of the rocker members 126, 134 to permit the bonding surface 144 having adhesive or bonding material thereon to contact a facial or lingual surface of the tooth.

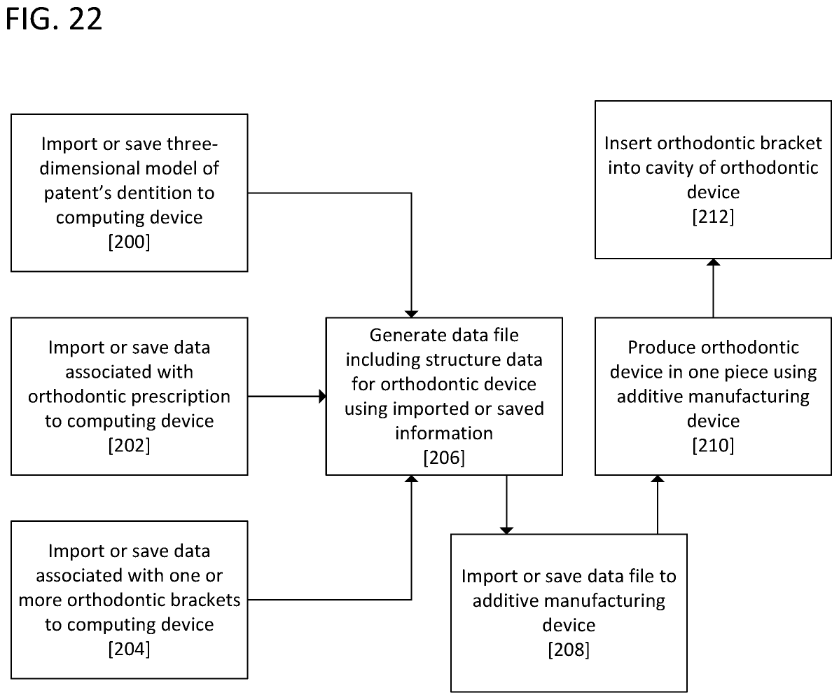

FIG. 22 shows an embodiment of a process of manufacturing an orthodontic device via additive manufacturing. The process comprises importing or saving to a computing device a three-dimensional model obtained from a patient's dentition 200, importing or saving data associated with an orthodontic prescription to the computing device 202, importing or saving data associated with a structure of one or more orthodontic brackets including bonding surfaces to the computing device 204. The components 200, 202, and 202 of the process can be performed in any order or simultaneously. The process further includes generating by the computing device a data file including structure data for an orthodontic device 206 through use of the three-dimensional model, the data associated with the orthodontic prescription, and the data associated with the structure of the one or more orthodontic brackets. The process further comprises importing or saving the data file to an additive manufacturing device 208 and using the additive manufacturing device to produce the orthodontic device 210 by additive manufacturing such that the orthodontic device is made in one piece. In some forms, a process of manufacturing an orthodontic device can further include inserting 212 one or more orthodontic brackets into respective one or more cavities of the orthodontic device.

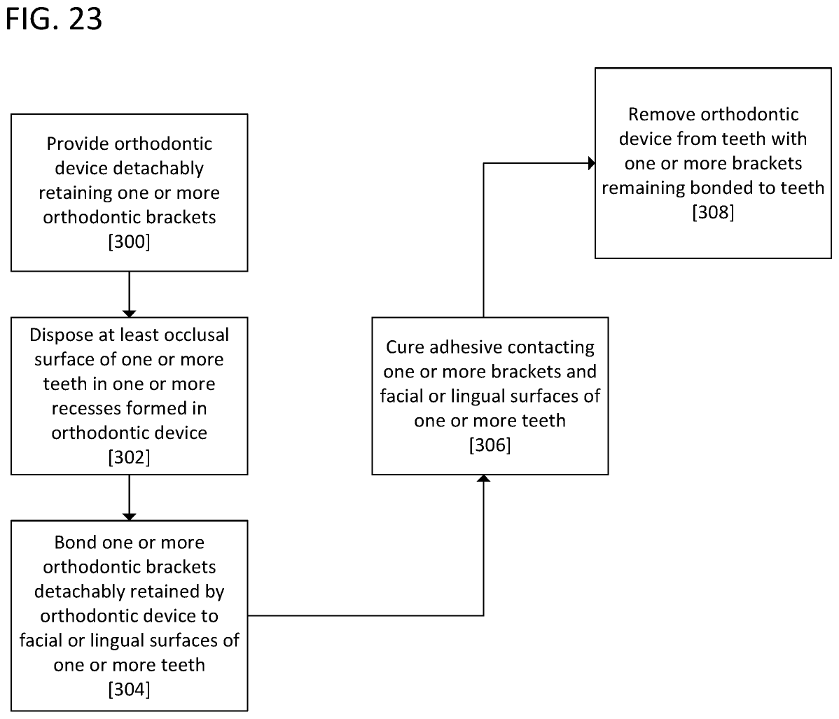

FIG. 23 shows an embodiment of a process of using an orthodontic device. The process comprises providing an orthodontic device 300 comprising a positioning member and a support member detachably retaining one or more orthodontic brackets including bonding surfaces. The process further includes 302 disposing at least an occlusal surface of one or more of the patient's teeth in one or more recesses of the positing member with the support member aligning bonding surfaces of the one or more brackets with facial or lingual surfaces of one or more of the patient's teeth. The process also includes bonding 304 one or more bonding surfaces of the orthodontic brackets to the facial or lingual surfaces of one or more teeth. The process can include curing 306 an adhesive contacting both a bonding surface and a facial or lingual surface of a patient's tooth. The process further includes removing 308 the positioning member and the support member of the orthodontic device from the one or more teeth with one or more orthodontic brackets remaining bonded to the one or more teeth.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. An orthodontic device comprising:
a positioning arm including a tooth receiving structure defining a recess structured to receive at least an occlusal surface of a patient's tooth; and
a support arm including a bracket receiving structure defining a cavity structured to detachably retain an orthodontic bracket including a bonding surface,
the orthodontic device having been made in one piece by an additive manufacturing process such that an end of the positioning arm is integrally and continuously formed to an end of the support arm, and
the positioning arm and the support arm being structured to align the bonding surface of the orthodontic bracket with a facial or lingual surface of the patient's tooth upon at least the occlusal surface of the tooth being received by the recess and the orthodontic bracket being retained by the cavity.

2. The orthodontic device according to claim 1, further comprising the orthodontic bracket detachably retained by the cavity.

3. The orthodontic device according to claim 1, wherein
the positioning arm includes a plurality of tooth receiving structures defining recesses structured to receive at least occlusal surfaces of a plurality of the patient's teeth,
the support arm includes a plurality of bracket receiving structures, each bracket receiving structure defines a cavity structured to detachably retain an orthodontic bracket including a bonding surface, and
the positioning arm and the support arm are structured to align bonding surfaces of a plurality of orthodontic brackets with facial or lingual surfaces of the patient's teeth upon at least the occlusal surfaces of the teeth being received by the recesses and the plurality of orthodontic brackets being retained by the cavities.

4. The orthodontic device according to claim 3, further comprising the plurality of orthodontic brackets detachably retained by the plurality of cavities.

5. The orthodontic device according to claim 1, wherein the integral and continuous connection between the end of the positioning arm and the end of the support arm is the sole connection between the positioning arm and the support arm.

6. The orthodontic device according to claim 1, wherein the recess comprises a receiving contour structured to receive at least the occlusal surface of the patient's tooth depicted in a three-dimensional model of the patient's dentition.

7. The orthodontic device according to claim 1, wherein the support arm and the positioning arm include an elastic material, and the orthodontic device further comprises:
a first rocker member including a fulcrum surface, a base fixed to the positioning arm, and a tip extending from the positioning arm, and
a second rocker member including a fulcrum surface, a base fixed to the support arm, and a tip extending from the support arm proximal the tip of the first rocker member,
the first rocker member and the second rocker member being structured to move the support arm away from a root axis of the recess of the positioning arm upon compressing together the first rocker member and the second rocker member such that a distance between the tip of the first rocker member and the tip of the second rocker member decreases and the fulcrum surface of the first rocker member actuates against the fulcrum surface of the second rocker member.

8. The orthodontic device according to claim 1, wherein the fulcrum surface of the first rocker member comprises a convex surface, the fulcrum surface of the second rocker member comprises a convex surface, and the first rocker member and the second rocker member are structured to move the support arm away from a root axis of the recess of the positioning arm upon compressing together the first rocker member and the second rocker member such that the distance between the tip of the first rocker member and the tip of the second rocker member decreases and the convex surface of the first rocker member rocks against the convex surface of the second rocker member.

9. The orthodontic device according to claim 1, wherein the support arm and the positioning arm include an elastic material, and the orthodontic device further comprises an actuation means structured to move the support arm away from a root axis of the recess of the positioning arm upon engagement of the actuation means.

10. An orthodontic device comprising:
a positioning member including first and second ends and a tooth receiving structure defining a recess formed distally from the first end of the positioning member, the recess being structured to receive a first portion of a patient's tooth; and
a support member including first and second ends and a bracket receiving structure defining a cavity formed distally from the first end of the support member, the cavity being structured to detachably retain an orthodontic bracket including a bonding surface,
the positioning member being integrally and continuously formed with the support member in one piece with the first end of the positioning member connected to the first end of the support member,
the positioning member and the support member being structured to align the bonding surface of the orthodontic bracket with a second portion of the patient's tooth upon the first portion of the tooth being received by the recess and the orthodontic bracket being retained by the cavity, and
the orthodontic bracket not being integrally and continuously formed with the positioning member and the support member.

11. The orthodontic device according to claim 10, the positioning member and the support member having been integrally and continuously formed in one piece by an additive manufacturing process.

12. The orthodontic device according to claim 10, wherein the recess is structured to receive at least an occlusal surface of the patient's tooth, the cavity is structured to detachably retain the orthodontic bracket, and the positioning member and the support member are structured to align the bonding surface of the orthodontic bracket with a facial or lingual surface the patient's tooth upon the occlusal surface of the tooth being received by the recess and the orthodontic bracket being retained by the cavity.

13. The orthodontic device according to claim 10, further comprising the orthodontic bracket detachably retained by the cavity.

14. The orthodontic device according to claim 10, wherein
the positioning arm includes a plurality of tooth receiving structures defining recesses structured to receive first portions of a plurality of the patient's teeth,
the support arm includes a plurality of bracket receiving structures, each bracket receiving structure defines a cavity structured to detachably retain an orthodontic bracket including a bonding surface, and
the positioning arm and the support arm are structured to align bonding surfaces of a plurality of orthodontic brackets with second portions of the patient's teeth upon the first portions of the teeth being received by the recesses and the plurality of orthodontic brackets being retained by the cavities.

15. The orthodontic device according to claim 14, wherein one of the recesses is formed proximal to the second end of the positioning member, and one of the cavities is formed proximal to the second end of the support member.

16. The orthodontic device according to claim 14, wherein the integral and continuous connection between the first end of the positioning member and the first end of the support member is the sole connection between the positioning member and the support member.

17. A process of manufacturing an orthodontic device, the process comprising:
importing or saving to a computing device a three-dimensional model obtained from a patient's dentition;
importing or saving data associated with an orthodontic prescription to the computing device;
importing or saving data associated with a structure of an orthodontic bracket including a bonding surface to the computing device;
generating by the computing device a data file including structure data for an orthodontic device through use of the three-dimensional model, the data associated with the orthodontic prescription, and the data associated with the structure of the orthodontic bracket, wherein the orthodontic device comprises:
a positioning arm including a tooth receiving structure defining a recess structured to receive at least an occlusal surface of a patient's tooth depicted in the three-dimensional model; and
a support arm including a bracket receiving structure defining a cavity structured to detachably retain the orthodontic bracket,
an end of the positioning arm being integrally and continuously formed to an end of the support arm, and the positioning arm and the support arm being structured to align the bonding surface of the orthodontic bracket with a facial or lingual surface of the patient's tooth upon at least the occlusal surface of the tooth being received by the recess and the orthodontic bracket being retained by the cavity,
importing or saving the data file to an additive manufacturing device; and
using the additive manufacturing device to produce the orthodontic device by additive manufacturing such that the orthodontic device is made in one piece.

18. The process of manufacturing an orthodontic device according to claim 17, further comprising inserting the orthodontic bracket into the cavity.

19. The process of manufacturing an orthodontic device according to claim 17, further comprising:
importing or saving data associated with structures of a plurality of orthodontic brackets including bonding surfaces to the computing device; and
generating by the computing device the data file including structure data for the orthodontic device through use of the three-dimensional model, the data associated with the orthodontic prescription, and the data associated with the structures of the plurality of the orthodontic brackets, wherein the orthodontic device comprises:
the positioning arm including a plurality of tooth receiving structures defining recesses structured to receive at least occlusal surfaces of a plurality of the patient's teeth depicted in the three-dimensional model,
the support arm includes a plurality of bracket receiving structures, each bracket receiving structure defines a cavity structured to detachably retain an orthodontic bracket including a bonding surface,
the positioning arm and the support arm being structured to align bonding surfaces of the plurality of orthodontic brackets with facial or lingual surfaces of the patient's teeth upon at least the occlusal surfaces of the teeth being received by the recesses and the plurality of orthodontic brackets being retained by the cavities.

20. The process of manufacturing an orthodontic device according to claim 19, further comprising inserting the plurality orthodontic brackets into the cavities.
